(19) United States
(12) Patent Application Publication
(10) Pub. No.: US 2023/0191272 A1
(43) Pub. Date: Jun. 22, 2023

(54) INFLATABLE MODEL WITH LIGHTING EFFECTS

(71) Applicant: Shenzhen Baiyi Technology Co., Ltd., Shenzhen (CN)

(72) Inventor: Hongjian WANG, Shenzhen (CN)

(21) Appl. No.: 17/588,878

(22) Filed: Jan. 31, 2022

(30) Foreign Application Priority Data
Dec. 16, 2021 (CN) 202123173910.4

(51) Int. Cl. A63H 27/10; F21V 3/02

(52) U.S. Cl. CPC A63H 27/10; F21V 3/026; A63H 2027/1058; A63H 2027/1075

(57) ABSTRACT

An inflatable model with lighting effects includes a light-transmissive inflatable body, an air supply component for inflating the interior of the light-transmissive inflatable body, and a main light source which emits light from the interior of the light-transmissive inflatable body. The light-transmissive inflatable body is divided into a plurality of decoration areas. Each decoration area is provided with at least one effect light source. According to the present invention, various lighting effect combinations on the inflatable model can be achieved, thus enriching the exhibition effect of the inflatable model. Therefore, the inflatable model in the present invention can attract attention of people more easily and is more suitable for activity meeting places with diversified lighting effect requirements such as Halloween, Christmas, and the like.

### CROSS REFERENCE TO RELATED APPLICATIONS

The present application claims priority from Chinese Patent Application No. 202123173910.4 filed on Dec. 16, 2021, all of which are hereby incorporated herein by reference.

### TECHNICAL FIELD

The invention relates to the technical field of inflatable products, in particular relates to an inflatable model with lighting effects.

### BACKGROUND

As a tool for media publicity and culture communication, the inflatable model is often used in the production of characters in cartoons and animations. As the characters in the cartoon and the animation are vivid and lovely, the shaped-related inflatable model can catch the eyes of people easily and becomes an object of public attention. Therefore, the inflatable model is more likely to become the focus of the public in an activity occasion, and is taken as an important means for information and culture communication. There are a wide variety of inflatable model products in market today, including arches, columns, wedding celebration, cartoons, product models, amusement facilities and water children's parks, the inflatable model products, for a wide range of use. In addition to common advertising industries, the inflatable model is involved in amusement, sports competition, television entertainment, wedding celebration, exhibition promotion even military field. The inflatable model is also frequently used for various exhibitions, garden parties, dancing parties and various activity meeting places and is used for introducing cultural information to the outside and creating a cultural atmosphere of the meeting places, for example, a common inflatable doll placed in an activity space mainly comprises a hollow inflatable body and an air blower, the inflatable body is made of a flexible material, an air inlet of the inflatable body is connected to the air blower to blow the air into the inflatable body to inflate and swell the inflatable body.

However, the inflatable model in the prior art is simple in function, especially does not have the light-emitting characteristic and is inevitably poor in interestingness; moreover, as the activities held in various festivals are more and more diversified, many activities can be held in places with dim light, such as Halloween meeting places and Christmas meeting places, and the like. In the festival occasion, the inflatable model is required to have a luminous effect, and is also required to have various lighting effect combinations to enrich the exhibition effects, so that the inflatable model in the prior art is not suitable for such activity occasions and still required to be improved.

### SUMMARY

The present invention thus is provided with an inflatable model with lighting effects which not only can achieve the light-emitting effect of the inflatable model, but can achieve various lighting effect combinations on the inflatable model, thus enriching the exhibition effect of the inflatable model.

According to the present invention, the inflatable model with lighting effects includes a light-transmissive inflatable body, an air supply component for inflating the light-transmissive inflatable body, and a main light source which is configured to emit light from the interior of the light-transmissive inflatable body. The light-transmissive inflatable body is divided into a plurality of decoration areas, and each decoration area is provided with an effect light source.

In accordance with the inflatable model with lighting effects of the invention, the light-transmissive inflatable body includes a main air bag which is inflated by the air supply component, and a plurality of branch air bags which extend outwards relative to the main air bag and are communicated with the main air bag, respectively. An inner width of the branch air bag is less than an inner width of the main air bag.

In accordance with the inflatable model with lighting effects of the invention, at least one of the plurality of branch air bags further includes a tail end air bag which is arranged at the tail end of the main air bag and is far away from an air outlet of the air supply component.

In accordance with the inflatable model with lighting effects of the invention, the tail end air bag is in form of a cone.

In accordance with the inflatable model with lighting effects of the invention, at least one of the plurality of branch air bags further includes a plurality of side air bags symmetrically arranged at two opposite sides of the main air bag, respectively.

In accordance with the inflatable model with lighting effects of the invention, an edge of at least one side air bag and/or the main air bag is provided with an outward-extending decorative sheet.

In accordance with the inflatable model with lighting effects of the invention, at least one of the plurality of decoration areas includes a plurality of flickering decoration areas. The effect light source includes a plurality of flickering effect lamps respectively arranged in various flickering decoration areas.

In accordance with the inflatable model with lighting effects of the invention, two flickering decoration areas are provided. The two flickering decoration areas are symmetrically arranged at a position, close to the top, of the light-transmissive inflatable body. The various flickering effect lamps are red flickering lamps respectively.

In accordance with the inflatable model with lighting effects of the invention, at least one of the plurality of decoration areas further includes a flame-simulating decoration area located at the bottom of the light-transmissive inflatable body. At least one of the plurality of effect light sources further has a flame effect lamp arranged at the flame-simulating decoration area.

Alternatively, at least one of the plurality of decoration areas further includes a colored light decoration area located at an end part of the light-transmissive inflatable body. At least one of the plurality of effect light sources includes a colored lamp arranged at the colored light decoration area.

In accordance with the inflatable model with lighting effects of the invention, a plurality of light-transmissive inflatable bodies are provided, and the various light-transmissive inflatable bodies are communicated with one another.

According to the present invention, the air supply component is used to inflate the light-transmissive inflatable body to swell and erect the inflatable model. Meanwhile, the main light source is emitted light from the interior of the light-transmissive inflatable body to show the light-emitting effect to the public, so that the inflatable model generates night lighting effect to cater to an activity meeting place with dim light. In addition, the light-transmissive inflatable body is further divided into a plurality of decoration areas, at least one decoration area is provided with at least one effect light source, respectively. During work, the effect light sources generate effect light in the decoration areas to form a plurality of partial lighting effects on the inflatable model, so that various decoration areas can conveniently exhibit different light effects additionally, and various lighting effect combinations can be achieved on the inflatable model, thus enriching the exhibition effect of the inflatable mode The inflatable model can attract attention of people more easily and is more suitable for activity meeting places with diversified lighting effect requirements such as Halloween and Christmas.

### BRIEF DESCRIPTION OF THE DRAWINGS

To describe the technical solutions in the embodiments of the invention or in the prior art more clearly, the following briefly introduces the accompanying drawings required for describing the embodiments or the prior art. Apparently, the accompanying drawings in the following description show merely some embodiments of the invention, and those of ordinary skill in the art may still derive other drawings from these accompanying drawings without creative efforts.

FIG. 1 is an internal perspective view according to an embodiment of the invention.

FIG. 2 is a structure diagram according to an embodiment of the invention.

FIG. 3 is a structure diagram according to an embodiment of the invention.

FIG. 4 is a structure diagram according to an embodiment of the invention.

FIG. 5 is a structure diagram of an embodiment according to the invention.

FIG. 6 is a structure diagram of an embodiment according to the invention.

FIG. 7 is a structure diagram of an embodiment according to the invention.

FIG. 8 is a structure diagram of an embodiment according to the invention.

FIG. 9 is a structure diagram of an embodiment according to the invention.

FIG. 10 is a structure diagram of an embodiment according to the invention.

### DESCRIPTION OF THE EMBODIMENTS

The following describes the embodiments of the invention in detail, and examples of the embodiments are illustrated in the accompanying drawings, where the same or similar reference numerals refer to the same or similar elements or elements having the same or similar function throughout. The embodiments described below with reference to the accompanying drawings are exemplary and only used for explaining the invention and are not to be construed as limiting thereof.

In the description of the invention, it needs to be understood that the orientation or position relationship indicated by the terms “center”, “longitudinal”, “transverse”, “length”, “width”, “thickness”, “above”, “below”, “front”, “back”, “left”, “right”, “vertical”, “horizontal”, “top”, “bottom”, “inside”, “outside”, “clockwise”, “counterclockwise”, “axial”, “radial”, “circumferential” and the like is based on the orientation or position relationship shown in the accompanying drawings, and is only used to facilitate the description of the invention and simplify the description rather than indicating or implying that the device or element referred to must have a specific orientation, be constructed and operated in a specific orientation, and thus cannot be construed as a limitation of the invention.

In addition, the terms “first” and “second” are used for descriptive purposes only and are not to be construed as indicating or implying relative importance or implicitly specifying the number of technical features indicated. Thus, the feature defined by “first” and “second” can explicitly or implicitly include one or more features. In the description of the invention, “plurality” means two or more, unless expressly specified otherwise.

In the invention, unless otherwise specified and limited, the terms “mounted”, “connected”, “connection”, “fixed” and the like should be understood in a broad sense, for example, fixed connection, or detachable connection, or integrated; mechanical connection, or electrical connection; direct connection, or indirect connection through an intermediate medium, or internal connection of two elements or the interaction of two elements. The specific meanings of the above terms in the invention may be understood by those of ordinary skill in the art on a case-by-case basis.

In the invention, unless otherwise specified and limited, the first feature “above” or “below” a second feature can be the first and second features being in direct contact, or the first and second features being in indirect contact through an intermediate medium. Moreover, the first feature being “above”, “on” and “over” the second feature may indicate that the first feature is above or at an inclined top of the second feature, or only indicate that a horizontal height of the first feature is higher than that of the second feature. The first feature being “below”, “under” and “beneath” the second feature may indicate that the first feature is below and at an inclined bottom of the second feature, or only indicate that a horizontal height of the first feature is lower than that of the second feature.

It also needs to be noted that to make the objective, the technical solutions and advantages of the invention more clearly, the following will describe the technical solutions in the invention clearly and completely with reference to the accompanying drawings in the invention. Apparently, the described embodiments are a part rather than all of the embodiments of the invention. Based on the embodiments in the invention, all other embodiments obtained by those of ordinary skill in the art without creative efforts shall fall within the scope of protection of the invention.

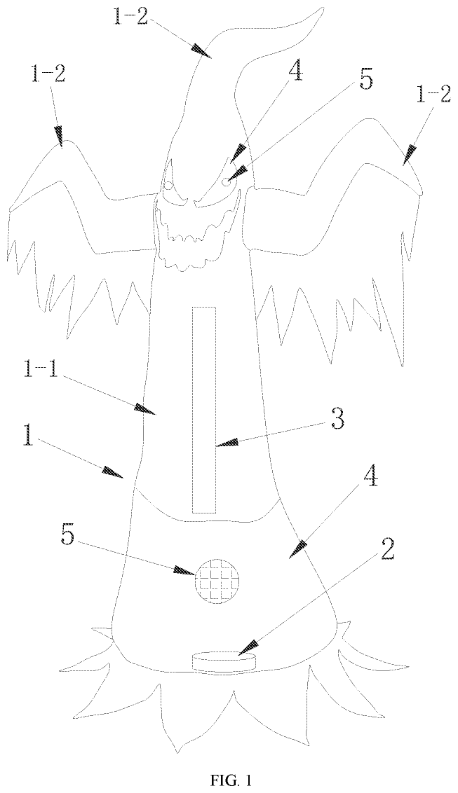

FIG. 1 shows a “White Ghost” in Halloween Party as a specific example, the “White Ghost” inflatable model with lighting effects includes a light-transmissive inflatable body 1, an air supply component 2, and a main light source 3. The light-transmissive inflatable body 1 is generally made of a flexible material and is light-transmissive. The air supply component 2 is used for inflating the interior of the light-transmissive inflatable body 1 to make the light-transmissive inflatable body 1 erected after swelled. The main light source 3 is configured to emit light from the interior of the light-transmissive inflatable body 1, which may be arranged in the light-transmissive inflatable body 1. The light-transmissive inflatable body 1 is divided into a plurality of decoration areas 4, and distribution positions of the decoration areas 4 can be arranged at will according to a modeling design of the inflatable model. In addition, at least one decoration area 4 is provided with effect light sources 5 which can generate light effects different from that of the main light source 3, so that the decoration areas 4 exhibit effect lighting different from that of the main light source, such as flickering lighting, changeable lighting, color-mixing lighting.

During use, the main light source 3-1 makes the light-transmissive inflatable body 1 emit lighting entirely, the contour of the inflatable model is exhibited. The effect light sources 5 can be selected to be arranged in the decoration areas 4 to generate a plurality of partial lighting effects on the inflatable model.

It should be understood that the inflatable model can be swelled and erected by inflating the interior of the light-transmissive inflatable body Land meanwhile, the main light source 3 is emitted lighting from the interior of the light-transmissive inflatable body 1 to exhibit the light-emitting effect to the public, so that the inflatable model can generate night lighting effect to cater to an activity meeting place with dim lighting. In addition, the light-transmissive inflatable body 1 is further divided into a plurality of decoration areas 4 provided with effect light sources 5. During work, the effect light sources 5 generate effect lighting in the decoration areas 4 to form a plurality of partial lighting effects on the inflatable model, so that various decoration areas 4 can exhibit different light effects additionally, and various lighting effect combinations can be achieved on the inflatable model. Such configuration thus can enrich the exhibition effect of the inflatable model, attract attention of people more easily and is more suitable for activity meeting places with diversified lighting effect requirements such as Halloween and Christmas.

According to one embodiment, the air supply component 2 includes an air blower. The air blower has high universality and can efficiently output high-pressure air flow to the interior of the light-transmissive inflatable body 1, so that the inflation model can maintain a swelling state for a long time.

According to one embodiment, the bottom of the light-transmissive inflatable body 1 is provided with an air inlet (not shown in the figures), an air outlet of the air supply component 2 is communicated with the air inlet of the light-transmissive inflatable body 1 from the bottom. Such configuration makes the inflatable model erected naturally after being swelled.

Certainly, when the inflatable model is selected to be placed in other directions, for example, when the inflatable model is transversely installed, the air inlet is formed in a side face of the light-transmissive inflatable body 1, and the air outlet of the air supply component 2 is communicated with the air inlet of the light-transmissive inflatable body 1 from the side face. With such configuration, the inflatable model is expanded transversely after swelled. The similar simple deformations all belong to the scope of protection of the invention.

According to one embodiment, a support (not shown in the figures) is arranged in the light-transmissive inflatable body 1, and a main light source 3 is arranged on the support. Alternatively, a bag body (not shown in the figures) is sewn in the light-transmissive inflatable body 1, and a main light source 3 is loaded in the bag body. Alternatively, a binding band (not shown in the figures) is sewn in the light-transmissive inflatable body 1, and a main light source 3 is fixed into the bag body by the binding band. Various optional structures mentioned above may facilitate the fixation of the main light source 3 inside the inflatable model.

In one embodiment, the main light source 3 and the effect light source 5 are respectively composed of LED lighting sets.

In one embodiment, a controller is further arranged in the light-transmissive inflatable body 1. A control end of the controller is electrically connected to the main light source 3 and the effect light lamp 5 respectively, so that the LED lights inside the main light source 3 and the effect light source 5 can be controlled effectively.

In one embodiment, the main light source 3, the effect light source 5, and the controller are connected to an external power source to be powered.

In one embodiment, as shown in FIG. 1, the light-transmissive inflatable body 1 comprises a main air bag 1-1 and a plurality of branch air bags 1-2. The air supply component 2 is used to inflate the interior of the main air bag 1-1, and the plurality of branch air bags 1-2 extend outwards respectively based on the main air bag 1-1 and are communicated with the main air bag 1-1, and an inner width of the branch air bag 1-2 is less than an inner width of the main air bag 1-1.

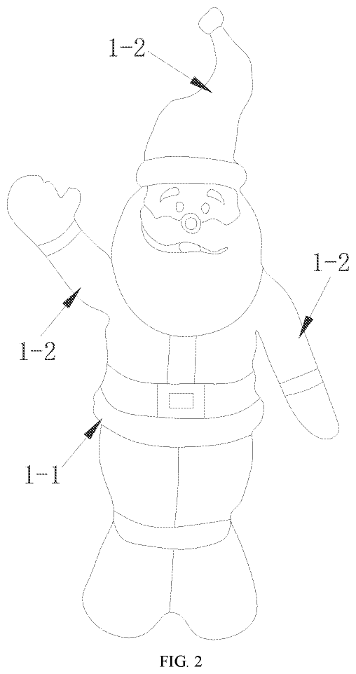

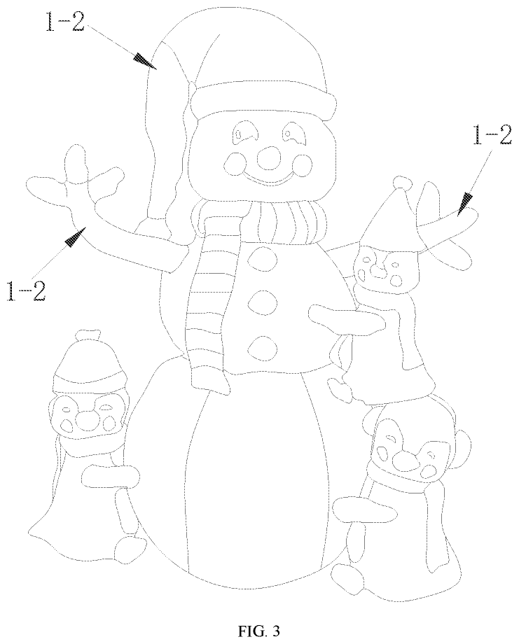

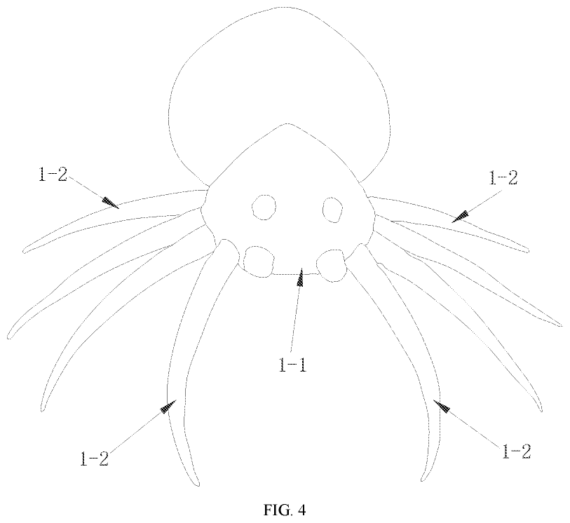

It should be understood that the branch air bags 1-2 are respectively communicated with the main air bag 1-1, with the configuration of the plurality of branch air bags 1-2 extending outwards relative to the main air bag 1-1, the inflatable model can form more different shapes conveniently, such as the “White Ghost” inflatable model as shown in FIG. 1, a “Santa Claus” inflatable model as shown in the FIG. 2, a “Snowman” inflatable model as shown in FIG. 3, and a “Spider” inflatable model as shown in FIG. 4 and the like more easily, which is more suitable for activity meeting places with diversified modeling design requirements in Halloween and Christmas, and can improve the interestingness of the inflatable model with the lighting effects. On the other hand, when the airflow output by the air supply component 2 is entered the branch air bags 1-2 from the main air bag 1-1, as the internal width of the branch air bag 1-2 is less than that of the main air bag 1-1, the airflow can be entered and filled all the branch air bags 1-2 more easily, thus maintaining the swelling state of all branch air bags 1-2. In combination with the internal light-emitting effect, the interestingness of the inflatable model can be further improved, for example, the “White Ghost” inflatable model shown in FIG. 1 can become more vivid, further enriching the exhibition effect of the inflatable model, and more likely to attract the attention of people.

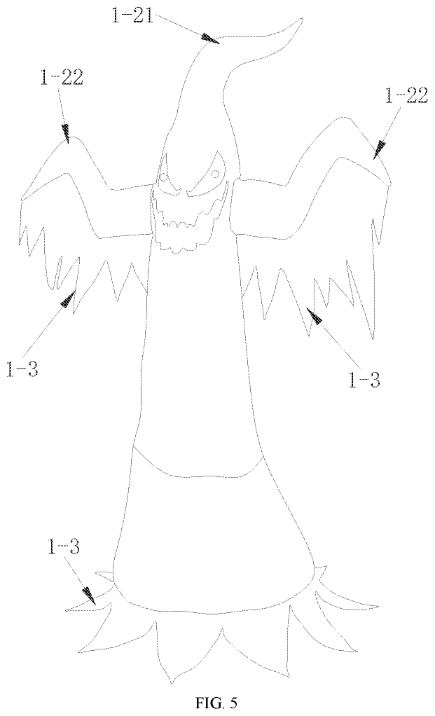

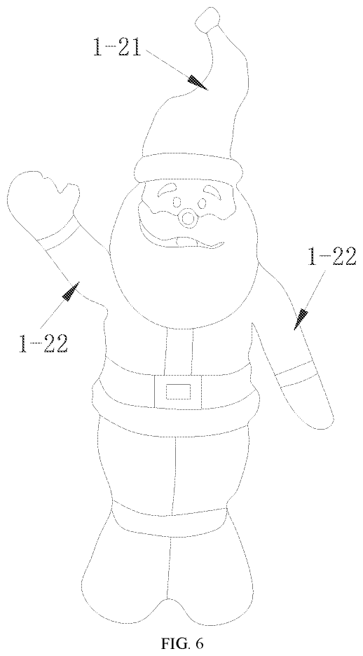

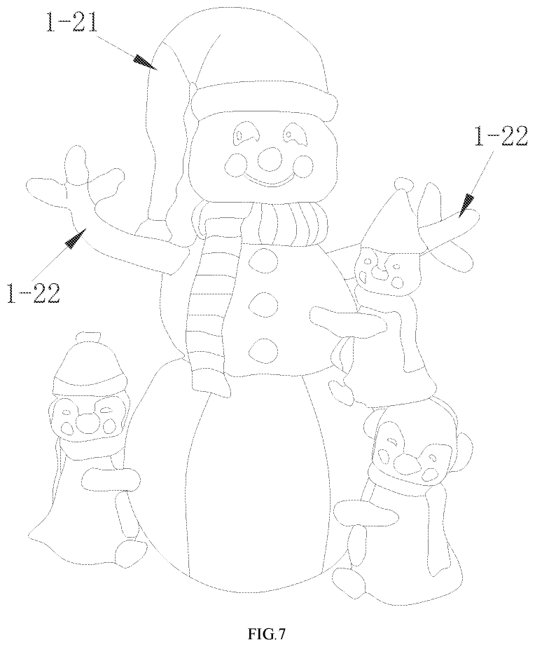

In one embodiment, as shown in FIG. 5, FIG. 6 and FIG. 7, the plurality of branch air bags 1-2 further comprise a tail end air bag 1-21, the tail end air bag 1-21 is formed at the tail end of the main air bag 1-1 and is far away from the air outlet of the air supply component 2, namely, the tail end air bag 1-21 is farthest away from the air outlet of the air supply component 2 in the light-transmissive inflatable body 1. It should be understood that such structure mode may allow the airflow to reach the tail end air bag 1-21 with the longest stroke, and makes the swinging effect of the tail end air bag 1-21 more obvious, thus making the inflatable model more active, and in combination with the internal light-emitting effect, the interestingness of the inflatable model can be further improved.

In one embodiment, the tail end air bag 1-21 is in form of a cone.

It may be understood that when the conical tail end air bag 1-21 swings along with the internal airflow, the tip part thereof can move along with the airflow more easily to generate a flying effect by the tail end air bag 1-21, and in combination with internal light-emitting effect, the interestingness of the inflatable model can be further improved.

In one embodiment, as shown in FIG. 5 to FIG. 7, a plurality of branch air bags 1-2 further includes a plurality of side air bags 1-22 which are symmetrically arranged at two opposite sides of the main air bag 1-1 respectively. Such configuration can construct tentacles of the “White Ghost” inflatable model shown in FIG. 5, tentacles of the “Santa Claus” inflatable model shown in FIG. 6, and tentacles of the “Snowman” inflatable model shown in FIG. 7. Therefore, the inflatable model is more suitable for activity meeting places with diversified lighting effect requirements such as Halloween and Christmas, and the interestingness of the inflatable model with lighting effects is further improved.

In one embodiment, as shown in FIG. 5, the edge of each side air bag 1-22 is provided with an outward-extending decorative sheet 1-3. It may be understood that the lighting effects in the light-transmissive inflatable body 1 can be mapped to various decorative sheets 1-3 through the various side air bags 1-22, which can increase the light-emitting area of the inflatable area and further improve the interestingness of the inflatable model, for example, the “White Ghost” inflatable model shown in FIG. 5 may become more vivid, further enriching the exhibition effect of the inflatable model, and attracting the attention of people more easily.

In one embodiment, as shown in FIG. 5, the bottom edge of the main air bag 1-1 is provided with a plurality of outward-extending decorative sheets 1-3. In this embodiment, the various decorative sheets 1-3 are circumferentially arranged at the bottom edge of the main air bag 1-1. Similarly, it may be understood that the lighting effects in the light-transmissive inflatable body 1 can be mapped to various decorative sheets 1-3 through the main air bag 1-1, which can increase the light-emitting area of the inflatable area and further improve the interestingness of the inflatable model, further enriching the exhibition effect of the inflatable model and attracting attention of people more easily.

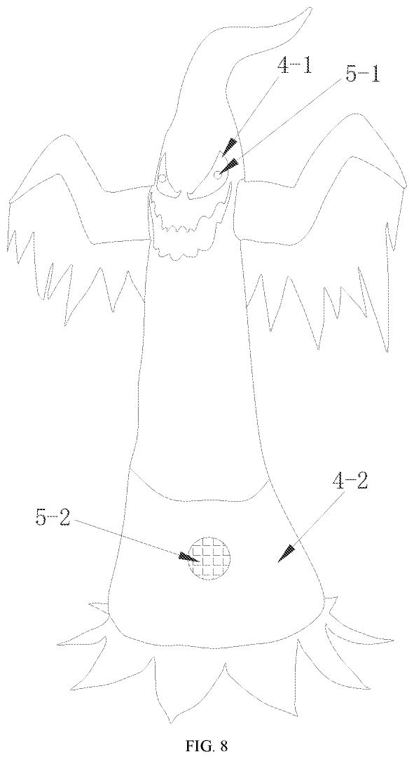

In one embodiment, in combination with FIG. 1 and FIG. 8, the plurality of decoration areas 4 comprise a plurality of flickering decoration areas 4-1, and the plurality of effect light sources 5 comprise a plurality of flickering effect lamps 5-1. The flickering effect lamps 5-1 are respectively arranged in the various flickering decoration areas 4-1.

It may be understood that, with the arrangement of the plurality of flickering decoration areas 4-1 on the light-transmissive inflatable body 1 and the flickering light effects exhibited to the public by the internal flickering effect lamps 5-1, various lighting effect combinations can be achieved on the inflatable model, the lighting effect exhibition effect of the inflatable model is further enriched, and meanwhile, a focus capable of attracting more attention of people can be achieved on the inflatable model.

Alternatively, as shown in FIG. 8, two flickering decoration areas 4-1 are provided, the two flickering decoration areas 4-1 are symmetrically arranged at positions, close to the top, of the light-transmissive inflatable body 1. Various flickering effect lamps 5-1 are red flickering lamps. Alternatively, as shown in FIG. 8, the eyes of the “White Ghost” inflatable model are set as the flickering decoration areas 4-1. The flickering of the eyes of the “White Ghost” inflatable model can be achieved under the flickering lighting effect of the flickering effect lamp 5-1. Meanwhile, the red flickering lighting effects generated by the eyes makes the “White Ghost” inflatable model become vivid, more interesting, more easily to attract the attention of people.

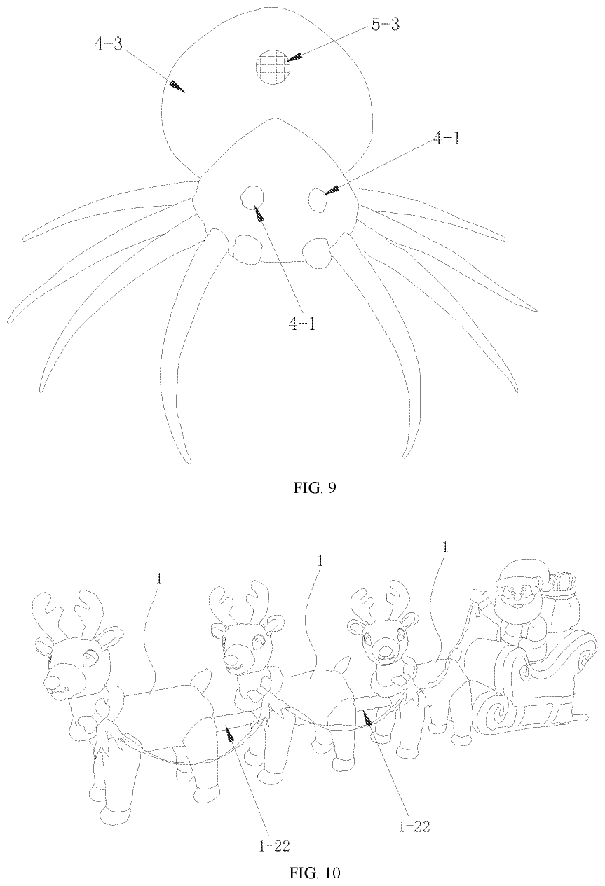

Alternatively, as shown in FIG. 9, the eyes of the “Spider” inflatable model are set as the flickering decoration areas 4-1. The flickering effect lamps 5-1 arranged in the “Spider” inflatable model can achieve the flickering of the eyes of the “Spider” inflatable model under the flickering lighting effects of the flickering effect lamps 5-1. Meanwhile, the red flickering lighting effects generated by the eyes mask the “Spider” inflatable model become vivid, more interesting, more easily to attract the attention of people.

In one embodiment, referring to FIG. 1 and FIG. 8, the plurality of decoration areas 4 further comprise a flame-simulating decoration area 4-2. In this embodiment, the flame-simulating decoration area 4-2 is located at the bottom of the light-transmissive inflatable body 1. The plurality of effect light sources 5 further comprises a flame effect lamp 5-2 which is arranged in the flame-simulating decoration area 4-2.

It may be understood that, with the arrangement of the flame-simulating decoration area 4-2 on the light-transmissive inflatable body 1 and the light effects of the simulated flame exhibited to the public by the internal flame effect lamps 5-2, various lighting effect combinations can be achieved on the inflatable model, further enriching the exhibition effect of the lighting effect of the inflatable model. Meanwhile, a focus capable of attracting more attention of people can be achieved on the inflatable model.

Alternately, as shown in FIG. 8, the bottom of the “White Ghost” inflatable model is set as the flame-simulating decoration area 4-2. The flame-simulating effect at the bottom of the “White Ghost” inflatable model can be achieved under the flickering lighting effect of the flame effect lamp 5-2, which is more conducive to making the “White Ghost” inflatable model become vivid, more interesting, and more easily to attract the attention of people.

In one embodiment, as shown in FIG. 9, the plurality of decoration areas 4 further includes a colored light decoration area 4-3. In this embodiment, the colored light decoration area 4-3 is located at the end part of the light-transmissive inflatable body 1. The plurality of effect light sources 5 further includes a colored lamp 5-3 which is arranged in the colored light decoration area 4-3.

It may be understood that the combination of various lighting effects can be achieved on the inflatable model with the arrangement of the colored light decoration area 4-3 on the light-transmissive inflatable body 1 and the color lighting effects with multiple colors exhibited to the public by the internal colored lamps 5-3, the lighting effect exhibition effect of the inflatable model is further enriched. Meanwhile, a focus capable of attracting more attention of people can be achieved on the inflatable model.

Alternately, as shown in FIG. 9, the tail part of the “Spider” inflatable model is set as the colored light decoration area 4-3, the colored lighting effect at the tail part of the “Spider” inflatable model can be achieved under the flickering lighting effect of the colored lamp 5-3, which makes the “Spider” inflatable model become more interesting, and more easily to attract the attention of people.

In one embodiment, as shown in FIG. 10, a plurality of light-transmissive inflatable body 1 is provided which are communicated with one another. Therefore, the plurality of inflatable models can be used to exhibit the lighting effects to the public at the same time, which is more suitable for being put into a large-scale activity place for use.

Alternately, as shown in FIG. 10, various light-transmissive inflatable bodies 1 can be communicated with one another through the side air bags 1-22.

In one embodiment, the surface of the light-transmissive inflatable body 1 is provided with a plurality of tethers (not shown in the figures), a dowel pile (not shown in the figures) is fixed to the outer end of each tether. During use, various dowel piles are respectively fixed to the ground to fix the inflatable model, thus preventing the inflatable model under a swelling state from being blown away by the airflow.

In the description of the specification, the description with reference to “one embodiment”, “some embodiments”, “an example”, “a specific example” or “some examples” or the like means that a particular feature, structure, material, or characteristic described in conjunction with the embodiment or example is included in at least one embodiment or example of the invention. In the present specification, the schematic representation of the above terms does not necessarily mean the same embodiment or example. Furthermore, the particular features, structures, materials, or characteristics described may be combined in a suitable manner in any one or more embodiments or examples. In addition, various embodiments or examples described in the specification, as well as features of various embodiments or examples, may be combined and combined by those skilled in the art without contradicting each other.

Finally, it should be noted that the above embodiments are only used to illustrate the technical solution of the invention rather than limiting it. Although the invention is described in detail with reference to the aforementioned embodiments, those of ordinary skill in the art should understand that the technical solutions described in the aforementioned embodiments can still be modified or part of the technical features can be equivalently replaced; and through the modification or replacement, the essence of the corresponding technical solution does not deviate from the spirit and scope of the technical solution of various embodiments of the invention.

What is claimed is:

1. An inflatable model with lighting effects, comprising:
a light-transmissive inflatable body;
an air supply component for inflating the light-transmissive inflatable body; and
a main light source which is configured to emit light from the interior of the light-transmissive inflatable body,
wherein the light-transmissive inflatable body is divided into a plurality of decoration areas, and each decoration area is provided with at least one effect light source.

2. The inflatable model with lighting effects according to claim 1, wherein the light-transmissive inflatable body comprises:
a main air bag, which is inflated by the air supply component; and
a plurality of branch air bags which extend outwards relative to the main air bag and are communicated with the main air bag,
wherein an inner width of each of the plurality of branch air bags is less than an inner width of the main air bag.

3. The inflatable model with lighting effects according to claim 2, wherein at least one of the plurality of branch air bags is provided with a tail end air bag which is arranged at the tail end of the main air bag and is far away from an air outlet of the air supply component.

4. The inflatable model with lighting effects according to claim 3, wherein the tail end air bag is in form of a cone.

5. The inflatable model with lighting effects according to claim 2, wherein at least one of the plurality of branch air bags is further provided with at least one a side air bag symmetrically arranged at two opposite sides of the main air bag.

6. The inflatable model with lighting effects according to claim 5, wherein an edge of the at least one side air bag is provided with an outward-extending decorative sheet.

7. The inflatable model with lighting effects according to claim 5, wherein an edge of the main air bag is provided with an outward-extending decorative sheet.

8. The inflatable model with lighting effects according to claim 1, wherein at least one of the plurality of decoration areas is provided with a plurality of flickering decoration areas, and the at least one of the effect light source is provided with a plurality of flickering effect lamps respectively arranged in the plurality of flickering decoration areas.

9. The inflatable model with lighting effects according to claim 8, wherein two flickering decoration areas are provided which are symmetrically arranged at a position, close to the top, of the light-transmissive inflatable body, and the plurality of flickering effect lamps are red flickering lamps.

10. The inflatable model with lighting effects according to claim 1, wherein at least one of the plurality of decoration areas is provided with a flame-simulating decoration area located at the bottom of the light-transmissive inflatable body, and the at least one of the effect light source is provided with a flame effect lamp arranged at the flame-simulating decoration area.

11. The inflatable model with lighting effects according to claim 1, wherein at least one of the plurality of decoration areas has a colored light decoration area located at an end part of the light-transmissive inflatable body, and the at least one effect light source is provided with a colored lamp arranged at the colored light decoration area.

12. The inflatable model with lighting effects according to claim 1, wherein a plurality of light-transmissive inflatable bodies are provided which are communicated with one another.
